(19) United States
(12) Patent Application Publication
(10) Pub. No.: US 2011/0167632 A1
(43) Pub. Date: Jul. 14, 2011

(54) DEVICE AND METHOD FOR MACHINING AND ASSEMBLING A PISTON

(76) Inventors: Achim Fedyna, Bundesland (DE); Gottfried Schnaitmann, Backnang (DE)

(21) Appl. No.: 12/671,604

(22) PCT Filed: Jun. 13, 2008
(86) PCT No.: PCT/EP2008/057478

§ 371 Date: Feb. 23, 2011

(30) Foreign Application Priority Data
Aug. 2, 2007 (DE) 102007036234.1

(51) Int. Cl. B23P 15/10; B23Q 39/00

(52) U.S. Cl. 29/888.043; 29/56.6; 29/888.042

(57) ABSTRACT

A device for machining and assembling a piston, comprising, a piston upper part; and a piston lower part; an upper work spindle and a lower work spindle, wherein the upper and lower work spindles are arranged coaxially to one another and are at least one of -actuated independently of one another and actuated together, such that one work spindle supports the piston upper part and the other work spindle supports the piston lower part; and a first and second tool carriage, wherein the tool carriages are actuated independently of one another, such that one tool carriage supports a tool for machining the piston upper part and the other tool carriage supports a tool for machining the piston lower part, wherein the device is configured such that both of the piston upper and lower parts are machined independently of one another, aligned with regard to one another, and joined to one another such that the piston parts remain clamped to the tool carriages in the interim.

The present invention relates to a device and method for machining and assembling a piston, which consists of a piston lower part and a piston upper part, of an internal combustion engine.

In internal combustion engines that are subject to high thermal and mechanical stresses, customarily pistons with an integrated cooling canal structure are used, through which structure a cooling medium is conducted during engine operation, in particular motor oil for piston cooling. One possibility for producing such pistons is to configure them as split in two parts that are subsequently assembled. An important aspect in the assembling of both of the piston parts is the positioning and alignment thereof prior to the actual assembling process. The more precise the alignment, the smaller the necessary manufacturing measurements for post-machining following the assembling process, which highly affects the cost-effectiveness of the process.

Embodiments of assembled pistons as well as their manufacturing method are disclosed in, for example, document DE 41 34 529 C2, document DE 41 34 530 C2, document DE 100 42 422 C1, document DE 100 47 258 C2, document DE 101 32 447 A1, document DE 101 52 316 A1, document DE 102 09 168 B4, as well as document DE 10 2004 038 464 A1.

The present invention addresses the problem of creating a device with which a machining and assembling of an assembled piston can be realised in a cost-effective manner.

This problem is solved according to the invention by the subject matter of independent claim 1. Advantageous embodiments are the subject matter of the dependent claims.

The invention is based on the general concept of creating a device for machining and assembling a piston, which consists of a piston upper part and a piston lower part and has two work spindles, which are arranged coaxially one to the other and on which a piston lower part and an associated piston upper part can be machined independently of one another and, subsequent to the machining process, can be directed toward one another and assembled together. One of the work spindles supports the piston upper part while the other work spindle supports the piston lower part. The device according to the invention furthermore has two tool carriages that can be actuated independently of one another and of which the one tool carriage supports a tool for machining the piston upper part and the other tool carriage supports a tool for machining the piston lower part. By means of both of the tool carriages, a machining of the piston upper part or of the piston lower part can therefore be effected independently of one another, it being also conceivable that the one and/or the other tool carriage can be so far displaced that it can machine both piston parts. It is possible with the device according to the invention to position or align both of the piston parts, subsequent to the machining process, directed one toward the other by means of the work spindles, it being thereby possible to minimise positioning errors of both of the piston parts with respect to one another since such errors are solely attributable to manufacturing and axis inaccuracies of the device. It is particularly advantageous that the device according to the invention is configured not only to machine but also simultaneously to assemble both of the piston parts and therefore an unclamping of both of the piston parts after the machining followed by a subsequent clamping in an additional tool can be dispensed with. Altogether, the device thus contributes to the optimisation of the manufacturing process of such assembled pistons and in particular to considerably increasing an alignment precision of both of the piston parts to each other.

The device advantageously has an assembling device that is configured to assemble both of the piston parts, in particular by screwing, adhering, soldering, welding, and/or thermally joining. Such an assembling device can, for example, have a laser or induction heating. By integrating the assembling process into the machining process of the piston, the manufacturing process of the piston can be rationalised altogether and designed with considerably reduced outlay since because of the increased alignment precision owing to the device according to the invention, a considerably reduced post-machining of the piston parts is required, if even necessary at all.

In an additional advantageous embodiment of the solution according to the invention, the device has a cleaning mechanism that is configured to clean a joint location prior to the assembly process of both of the piston parts. Such a cleaning mechanism can, for example, be configured in the form of a blower having a jet nozzle that cleans the joint location prior to assembling both of the piston parts by means of compressed air, for example. A particularly high-quality assembly of both of the piston parts can hereby be achieved.

In yet another advantageous embodiment of the solution according to the invention, at least one work spindle, for screwing together both of the piston parts, can be impinged upon with a pre-defined torque. This is highly advantageous because the assembling process can be controlled in terms of quality since both of the piston parts are screwed one to the other with a precisely pre-defined and controllable torque, the preset torque representing an optimal torque for the seal effect of both of the piston parts. This is particularly important in instances in which a cooling canal is configured between the piston parts, which cooling canal must be sealed in the region of joint locations between the piston upper part and the piston lower part.

Additional important features and advantages of the invention can be found in the dependent claims, in the drawings, and in the pertinent description of the figures with reference to the drawings.

It is understood that the features described above and those to be described in what follows can be used not only in the particular cited combination, but also in other combinations or independently without departing from the scope of the present invention.

Preferred embodiments of the invention are shown in the drawings and are described in more detail in the following description, the same reference numerals referring to components which are the same or functionally the same or similar.

It is shown, respectively schematically, in

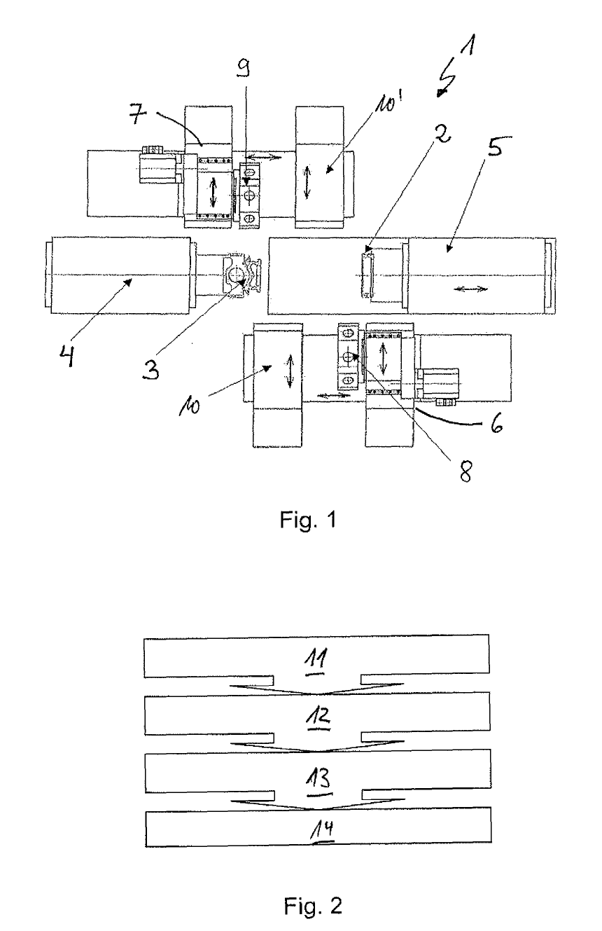

FIG. 1 a device according to the invention for machining and assembling a piston,

FIG. 2 a highly schematicised process flow of the method according to the invention for machining and assembling the piston.

Corresponding to FIG. 1, the device 1 according to the invention for machining and assembling a piston, which consists of a piston upper part 2 and a piston lower part 3, of an internal combustion engine, has two work spindles 4 and 5 that are arranged coaxially to one other and can be actuated independently of one another. The work spindle 4 supports the piston lower part 3 while the work spindle 5 supports the piston upper part 2. The device 1 according to the invention furthermore has two tool carriages 6 and 7 that can be actuated independently of one another and of which the one tool carriage 6 supports a tool 8 for machining the piston upper part 2 and the other tool carriage 7 supports a tool 9 for machining the piston lower part 3. The device 1 is generally so configured that both of the piston parts 2 and 3 can be machined independently of one another, aligned with regard to one another, and joined to one another without it being necessary to dismantle said pistons from the work spindles 4, 5 in the interim.

The device 1 according to the invention moreover has an assembling device 10 or 10′ that is configured to assemble both of the piston parts 2 and 3, in particular by screwing, adhering, soldering, welding, and/or thermally joining. The assembling device 10, 10′ can have, for example, a laser or induction heating for purposes of thermal joining.

A screwing together of both of the piston parts 2 and 3, in particular a thermal screwing together of both of the piston parts 2 and 3, can be effected by a rotating of at least one of the two work spindles 4, 5 with the simultaneous driving of the same work spindle in a direction onto the other piston part 3, 2. The device 1 can be configured in such a manner that at least one work spindle 4, 5 can be impinged upon by a pre-defined torque in such a manner that both of the piston parts 2, 3 can be screwed together with a precisely defined fastening torque.

The device 1 can optionally have a cleaning mechanism that is not shown and that is configured to clean a joint location of both of the piston parts 2, 3 prior to the assembly process. Such a cleaning mechanism can, for example, be configured as a nozzle impinged upon with compressed air, which blasts the joint locations prior to assembling both of the piston parts 2, 3, thereby cleaning them.

According to FIG. 1, at least the work spindle 5 can be displaced in the axial direction onto the work spindle 4 or away therefrom, the tool carriages 6, 7 with the associated tools 8, 9 as well as the assembling device 10, 10′ being mounted in such a manner as to be likewise displaceable so that a problem-free machining or assembling of both of the piston parts 2, 3 is possible.

According to FIG. 2, one possible process flow for machining and assembling the piston, which consists of a piston upper part 2 and a piston lower part 3, is shown with different process steps. Initially in one process step 11, both of the piston parts 2, 3 are clamped and machined, particularly pre-machined, independently of one another on both of the work spindles 4, 5 arranged coaxially to one another. In the following work step 12, both of the piston parts 2, 3 are aligned to one another or positioned relative to one another on both of the work spindles 4, 5. Prior to the actual assembly process, the joint locations between the piston upper part 2 and the piston lower part 2 are optionally cleaned in process step 13. In process step 14, both of the piston parts 2, 3 are ultimately joined together, that is to say they are screwed, adhered, and/or soldered to one another in particular, both of the piston parts 2, 3 being able to remain on the associated work spindles 4, 5 between process step 11 and process step 14.

It is thereby achieved that subsequent to a machining process, both of the piston parts 2, 3 can be positioned opposite one another and aligned by means of the machine axes, thereby making it possible to reduce to a minimum positioning errors of both of the piston parts 2, 3 with regard to one another since a potential positioning error can now be attributed solely to manufacturing and axis inaccuracies of the device 1.

Moreover, the device 1 according to the invention offers the particular advantage that not only the pre-machining or primary machining of both of the piston parts 2, 3 can be undertaken, but said parts can also be assembled to one another in a subsequent process step 14 without any additional handling whatsoever. A rationalisation of the manufacturing process is hereby achieved by means of which expenditures can be reduced. The assembling can be carried out by means of a thermal joining process, the piston upper part 2 being, for example, heated to a great extent and/or the piston lower part 3 being cooled to a great extent. Subsequent thereto, it is possible for both of the piston parts 2 and 3 to be screwed to one another problem-free, a reliable shrink-fit between both of the piston parts 2 and 3 resulting upon the subsequent cooling of the piston upper part 2 or the subsequent heating of the piston lower part 3.

1. A device for machining and assembling a piston, comprising: a piston upper part; and a piston lower part; an upper work spindle and a lower work spindle, wherein the upper and lower work spindles are arranged coaxially to one another and are at least one of actuated independently of one another and actuated together, such that one work spindle supports the piston upper part and the other work spindle supports the piston lower part; and
a first and second tool carriage, wherein the tool carriages are actuated independently of one another, such that one tool carriage supports a tool for machining the piston upper part and the other tool carriage supports a tool for machining the piston lower part,
wherein the device is configured such that both of the piston upper and lower parts are machined independently of one another, aligned with regard to one another, and joined to one another such that the piston parts remain clamped to the tool carriages in the interim.

2. The device as specified in claim 1, wherein the device has at least one assembling device configured to assemble the upper piston part and the lower piston part, by at least one of screwing, adhering, soldering, welding, and thermally joining.

3. The device as specified in claim 1, wherein the assembling device includes at least one of a laser heating and induction heating.

4. The device as specified in claim 1, wherein rotating at least one work spindle upon simultaneous driving of the same work spindle effects thermally screwing together both of the piston parts.

5. The device as specified in claim 1, wherein both of the piston parts are screwed together by applying a predetermined torque to at least one work spindle.

6. The device as specified in claim 1, further comprising: a cleaning mechanism, configured to clean at least a joint location prior to the assembly process.

7. A method for machining and assembling a piston, having a piston upper part and a piston lower part, comprising:
clamping both of the piston parts to two work spindles;
machining the piston parts independently of one another on two work spindles;
arranging the work spindles coaxially to one another;
aligning both of the piston parts with respect to one another on both of the work spindles;
cleaning a joint location between the piston upper part and the piston lower part; and
joining both of the piston parts to each other without having to be unclamped in the interim.

8. The method as specified in claim 7, wherein both of the piston parts are at least one of screwed, adhered, soldered, welded, and thermally joined to one another.

9. The method as specified in claim 7, further comprising:
heating at least one of the piston lower part and the piston upper part with at least one of a laser heat and an induction heat; and
joining thermally the piston lower part to the piston upper part.

10. The device as specified in claim 2, wherein the assembling device includes at least one of a laser heating and induction heating.

11. The device as specified in claim 2, wherein rotating at least one work spindle upon simultaneous driving of the same work spindle effects thermally screwing together both of the piston parts.

12. The device as specified in claim 3, wherein rotating at least one work spindle upon simultaneous driving of the same work spindle effects thermally screwing together both of the piston parts.

13. The device as specified in claim 2, wherein both of the piston parts are screwed together by applying a predetermined torque to at least one work spindle.

14. The device as specified in claim 3, wherein both of the piston parts are screwed together by applying a predetermined torque to at least one work spindle.

15. The device as specified in claim 4, wherein both of the piston parts are screwed together by applying a predetermined torque to at least one work spindle.

16. The device as specified in claim 2, further comprising: a cleaning mechanism, configured to clean at least a joint location prior to the assembly process.

17. The device as specified in claim 3, further comprising: a cleaning mechanism, configured to clean at least a joint location prior to the assembly process.

18. The device as specified in claim 4, further comprising: a cleaning mechanism, configured to clean at least a joint location prior to the assembly process.

19. The device as specified in claim 5, further comprising: a cleaning mechanism, configured to clean at least a joint location prior to the assembly process.

20. The method as specified in claim 8, further comprising:
heating at least one of the piston lower part and the piston upper part with at least one of a laser heat and an induction heat; and
joining thermally the piston lower part to the piston upper part.
